(19) United States
(12) Patent Application Publication
(10) Pub. No.: US 2014/0280713 A1
(43) Pub. Date: Sep. 18, 2014

(54) Proxy Communication Between Devices in an Electrical Power System

(71) Applicant: SCHWEITZER ENGINEERING LABORATORIES, INC., Pullman, WA (US)

(72) Inventors: David J. Dolezilek, Pullman, WA (US); Benjamin S. Day, Pullman, WA (US); Dennis Gammel, Pullman, WA (US); Ryan Bradetich, Pullman, WA (US); Jerry J. Bennett, Pullman, WA (US); Christopher Ewing, Colfax, WA (US); Shankar V. Achanta, Pullman, WA (US)

(73) Assignee: SCHWEITZER ENGINEERING LABORATORIES, INC., Pullman, WA (US)

(21) Appl. No.: 13/841,564

(22) Filed: Mar. 15, 2013

(51) Int. Cl. H04L 29/06; H04L 29/08

(52) U.S. Cl. CPC H04L 69/03; H04L 67/32
USPC 709/217

(57) ABSTRACT

Systems and methods for exchanging messages between network devices and intelligent electronic devices of the electric power generation and delivery system are disclosed herein. In certain embodiments, a method performed by a network device for managing the exchange of messages between a first intelligent electronic device (IED) and a second IED included in an electrical power generation and delivery system may include receiving one or more messages configured according to a first communication protocol from the first IED. Based on information regarding one or more communication capabilities of the second IED, a second communication protocol may be determined. The message be reconfigured according to the second communication protocol to generate at least one reconfigured message. The reconfigured message may then be transmitted to the second IED.

### TECHNICAL FIELD

This disclosure relates to systems and methods for managing communication between devices of an electric power generation and delivery system, and more particularly, to systems and methods for exchanging messages between network devices and intelligent electronic devices of the electric power generation and delivery system.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified diagram of an example of an electric power generation and delivery system consistent with certain embodiments disclosed herein.

FIG. 2 illustrates an conceptual timing diagram showing transmission of messages by an intelligent electronic device prior to and after a data state change consistent with embodiments disclosed herein.

FIG. 3A illustrates a system of intelligent electronic devices communicatively coupled with a network via a plurality of network devices consistent with embodiments disclosed herein.

FIG. 3B illustrates a system of intelligent electronic devices communicatively coupled with a network via a plurality of network devices and network radios consistent with embodiments disclosed herein.

FIG. 4A illustrates communication between a plurality of intelligent electronic devices and network devices consistent with embodiments disclosed herein.

FIG. 4B illustrates communication between a plurality of intelligent electronic devices and network devices consistent with embodiments disclosed herein.

FIG. 5 illustrates communication between a plurality of intelligent electronic devices consistent with embodiments disclosed herein.

FIG. 6 illustrates communication between a plurality of intelligent electronic devices consistent with embodiments disclosed herein.

FIG. 7 illustrates a flow chart of a method of communicating between intelligent electronic devices and/or network devices consistent with embodiments disclosed herein.

FIG. 8 illustrates flow chart of another method of communicating between intelligent electronic devices and/or network devices consistent with embodiments disclosed herein.

FIG. 9 illustrates another flow chart of yet another method of communicating between intelligent electronic devices and/or network devices consistent with embodiments disclosed herein.

FIG. 10 illustrates a block diagram of a device for implementing certain embodiments of the systems and methods disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (ASIC), PAL, PLA, PLD, field programmable gate array (FPGA), or any other customizable or programmable device.

Electrical power generation and delivery systems are designed to generate, transmit, and distribute electrical energy to loads. Electrical power generation and delivery systems may include equipment, such as electrical generators, electrical motors, power transformers, power transmission and distribution lines, circuit breakers, switches, buses, transmission lines, voltage regulators, capacitor banks, and the like. Such equipment may be monitored, controlled, automated, and/or protected using intelligent electronic devices (IEDs) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (PLCs), programmable automation controllers, input and output modules, governors, exciters, statcom controllers, static VAR compensator (SVC) controllers, on-load tap changer (OLTC) controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

IEDs may communicate with other IEDs, monitored equipment, and/or network devices using one or more suitable communication protocols and/or standards. In certain embodiments, IEDs, monitored equipment, and/or network devices included in an electric power generation and delivery system may communicate using one or more bandwidth conservative protocols. In further embodiments, IEDs, monitored equipment, and/or network devices included in an electric power generation and delivery system may communicate using one or more less-bandwidth conservative protocols. In certain circumstances, an electric power generation and delivery system may include a first set of IEDs, monitored equipment, and/or network devices that are configured are configured to communicate using one or more bandwidth conservative protocols and a second set that are configured to communicate using one or more less-bandwidth conservative protocols.

In certain embodiments one or more IEDs, monitored equipment, and/or network devices included in an electric power generation and delivery system may communicate using a variety of protocols, such as IEC 61850 GOOSE (Generic Object Oriented Substation Events), SV (Sampled Values), MMS (Manufacturing Messaging Specification), SEL Fast Message (FM), and/or the like. In further embodiments, one or more IEDs, monitored equipment, and/or network devices included in an electric power generation and delivery system may communicate using a Mirrored Bits® protocol, a Distributed Network Protocol (DNP), and or any other suitable communication protocol. In some embodiments, IEC 61850 GOOSE, MMS, or the like may be considered a less-bandwidth conservative communication protocol, whereas Mirrored Bits®, DNP, FM, or the like may be considered bandwidth conservative communication protocols.

IEDs, monitored equipment, and/or network devices may communicate (e.g., transmit and/or receive) messages (e.g., GOOSE, Mirrored Bits®, and/or DNP messages) that include bits, bit pairs, measurement values, and/or any other relevant data elements. Certain communication protocols (e.g., GOOSE) may allow a message generated from a single device to be transmitted to multiple receiving devices (e.g., subscriber devices and/or particular receiving devices designated or identified in a message). In certain embodiments, (e.g., embodiments that utilize GOOSE), a message may be part of a message stream that includes multiple redundant copies of the message and/or similar messages. Messages in the message stream may include one or more control instructions, monitored system data, communications with other IEDs, monitored equipment and/or other network devices, and/or any other relevant communication, message, or data. In further embodiments, messages in the message stream may provide an indication as to a data state (e.g., a measured data state) of one or more components and/or conditions within an electrical power generation and delivery system.

Systems and methods disclosed herein allow for communication between IEDs, monitored equipment, and/or network devices that implement a variety of communication protocols. For example, a first IED in a system may be configured to utilize a less-bandwidth conservative protocol (e.g., GOOSE) while a second IED may be configured to utilize a bandwidth conservative protocol (e.g., Mirrored Bits® and/or DNP). One or more network devices communicatively coupled with the first IED and the second IED may receive a message from the first IED and transmit a message to the second IED in a protocol that the second IED understands. For example, the one or more network devices may receive a message in a less-bandwidth conservative protocol from the first IED and may transmit a corresponding message to the second IED in a bandwidth conservative protocol. In this manner, communication between IEDs, monitored equipment, and/or network devices implementing variety of communication protocols may be facilitated.

Further systems and methods disclosed herein may allow network devices to package a plurality of messages received from one or more IEDs into a single message and to transmit the packaged single message to an intended receiving device (e.g., a receiving IED). In certain embodiments, by packaging multiple messages into a single message, high network message traffic and/or congestion at an intended receiving device may be reduced. For example, a receiving IED may include a finite receiving FIFO that may only store a predetermined number of messages, and thus may not be capable of storing certain messages if a significant number of messages are received in a relatively short period (e.g., during periods of high network message traffic). Similarly, a network switch may have a limited transfer rate that is lower than its receiving rate. For example, a network switch may have a 1 MB/second data transmission rate but a receiving rate that is substantially greater, thereby creating an asymmetry between inbound and outbound communication rates. If such a network switch includes a finite receiving and/or transmitting buffer and a substantial amount of data (e.g., multiple messages) is received by such a network switch in a short period of time, the network switch may be unable to transmit received messages before the finite buffers become full and thus messages may be dropped or lost. In further circumstances, network devices and/or IEDs may have insufficient computing resources to process network traffic at “wire speed.” Packaging multiple messages into a single message may reduce issues caused by such high network message traffic and/or congestion conditions.

FIG. 1 illustrates a simplified diagram of an example of an electric power generation and delivery system 100 consistent with embodiments disclosed herein. The systems and methods described herein may be applied and/or implemented in the system electric power generation and delivery system 100 illustrated in FIG. 1. The electric power generation and delivery system 100 may include, among other things, an electric generator 102, configured to generate an electrical power output, which in some embodiments may be a sinusoidal waveform. Although illustrated as a one-line diagram for purposes of simplicity, an electrical power generation and delivery system 100 may also be configured as a three-phase power system.

A step-up power transformer 104 may be configured to increase the output of the electric generator 102 to a higher voltage sinusoidal waveform. A bus 106 may distribute the higher voltage sinusoidal waveform to a transmission line 108 that in turn may connect to a bus 120. In certain embodiments, the system 100 may further include one or more breakers 112-118 that may be configured to be selectively actuated to reconfigure the electric power generation and delivery system 100. A step down power transformer 122 may be configured to transform the higher voltage sinusoidal waveform to lower voltage sinusoidal waveform that is suitable for delivery to a load 124.

The IEDs 126-138, illustrated in FIG. 1, may be configured to control, monitor, protect, and/or automate the one or more elements of the electric power generation and delivery system. An IED may be any processor-based device that monitors, controls, automates, and/or protects monitored equipment within an electric power generation and delivery system (e.g., system 100). In some embodiments, the IEDs 126-138 may gather status information from one or more pieces of monitored equipment (e.g., generator 102). Further, the IEDs 126-138 may receive information concerning monitored equipment using sensors, transducers, actuators, and the like. Although FIG. 1 illustrates one IED monitoring transmission line 108 (e.g., IED 134) and another IED controlling a breaker (e.g., IED 136), these capabilities may be combined into a single IED.

FIG. 1 illustrates IEDs 126-138 performing various functions for illustrative purposes and does not imply any specific arrangements or functions required of any particular IED. In some embodiments, IEDs 126-138 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. Further, IEDs 126-138 may be configured to communicate calculations, such as phasors (which may or may not be synchronized as synchrophasors), events, fault distances, differentials, impedances, reactances, frequency, and the like. IEDs 126-138 may also communicate settings information, IED identification information, communications information, status information, alarm information, and the like. Information of the types listed above, or more generally, information about the status of monitored equipment, may be generally referred to herein as monitored system data.

In certain embodiments, IEDs 126-138 may issue control instructions to the monitored equipment in order to control various aspects relating to the monitored equipment. For example, an IED (e.g., IED 136) may be in communication with a circuit breaker (e.g., breaker 114), and may be capable of sending an instruction to open and/or close the circuit breaker, thus connecting or disconnecting a portion of a power system. In another example, an IED may be in communication with a recloser and capable of controlling reclosing operations. In another example, an IED may be in communication with a voltage regulator and capable of instructing the voltage regulator to tap up and/or down. Information of the types listed above, or more generally, information or instructions directing an IED or other device to perform a certain action, may be generally referred to as control instructions.

IEDs 126-138 may be communicatively linked together using a data communications network, and may further be communicatively linked to a central monitoring system, such as a supervisory control and data acquisition (SCADA) system 142, an information system (IS) 144, and/or a wide area control and situational awareness (WCSA) system 140. In certain embodiments, various components of the electrical power generation and delivery system 100 illustrated in FIG. 1 may be configured to generate, transmit, and/or receive messages (e.g. GOOSE messages), or communicate using any other suitable communication protocol. For example, an automation controller 150 may communicate certain control instructions to IED 126 via messages using a GOOSE communication protocol. In certain embodiments, various components of the electrical power generation and delivery system 100 may communicate using one or more bandwidth conservative protocols (e.g., Mirrored Bits® DNP, or the like) and/or one or more less-bandwidth conservative protocols (e.g. GOOSE).

The illustrated embodiments are configured in a star topology having an automation controller 150 at its center, however, other topologies are also contemplated. For example, the IEDs 126-138 may be communicatively coupled directly to the SCADA system 142 and/or the WCSA system 140. The data communications network of the system 100 may utilize a variety of network technologies, and may comprise network devices such as modems, routers, firewalls, virtual private network servers, and the like. Further, in some embodiments, the IEDs 126-138 and other network devices (e.g., one or more communication switches or the like) may be communicatively coupled to the communications network through a network communications interface.

Consistent with embodiments disclosed herein, IEDs 126-138 may be communicatively coupled with various points to the electric power generation and delivery system 100. For example, IED 134 may monitor conditions on transmission line 108. IEDs 126, 132, 136, and 138 may be configured to issue control instructions to associated breakers 112-118. IED 130 may monitor conditions on a bus 152. IED 128 may monitor and issue control instructions to the electric generator 102.

In certain embodiments, communication between and/or the operation of various IEDs 126-138 and/or higher level systems (e.g., SCADA system 142 or IS 144) may be facilitated by an automation controller 150. The automation controller 150 may also be referred to as a central IED, access controller, communications processor, and/or information processor.

The IEDs 126-138 may communicate a variety of types of information to the automation controller 150 including, but not limited to, status and control information about the individual IEDs 126-138, IED settings information, calculations made by the individual IEDs 126-138, event (e.g., a fault) reports, communications network information, network security events, and the like. In some embodiments, the automation controller 150 may be directly connected to one or more pieces of monitored equipment (e.g., electric generator 102 or breakers 112-118).

The automation controller 150 may also include a local human machine interface (HMI) 146. In some embodiments, the local HMI 146 may be located at the same substation as automation controller 150. The local HMI 146 may be used to change settings, issue control instructions, retrieve an event report, retrieve data, and the like. The automation controller 150 may further include a programmable logic controller accessible using the local HMI 146. In certain embodiments, the automation controller 150 and/or any other system illustrated in FIG. 1 may be further communicatively coupled with one or more remote systems or IEDs including, for example, a remote SCADA system 153 and/or a remote WCSA system 154 via one or more network devices 156, 158 and/or interfaces.

The automation controller 150 may also be communicatively coupled to a time source (e.g., a clock) 148. In certain embodiments, the automation controller 150 may generate a time signal based on the time source 148 that may be distributed to communicatively coupled IEDs 126-138. Based on the time signal, various IEDs 126-138 may be configured to collect and/or calculate time-aligned data points including, for example, synchrophasors, and to implement control instructions in a time coordinated manner. In some embodiments, the WCSA system 140 may receive and process the time-aligned data, and may coordinate time synchronized control actions at the highest level of the electrical power generation and delivery system 100. In other embodiments, the automation controller 150 may not receive a time signal, but a common time signal may be distributed to IEDs 126-138.

The time source 148 may also be used by the automation controller 150 for time stamping information and data. Time synchronization may be helpful for data organization, real-time decision-making, as well as post-event analysis. Time synchronization may further be applied to network communications. The time source 148 may be any time source that is an acceptable form of time synchronization, including, but not limited to, a voltage controlled temperature compensated crystal oscillator, Rubidium and Cesium oscillators with or without a digital phase locked loops, microelectromechanical systems (MEMS) technology, which transfers the resonant circuits from the electronic to the mechanical domains, or a global positioning system (GPS) receiver with time decoding. In the absence of a discrete time source 148, the automation controller 150 may serve as the time source 148 by distributing a time synchronization signal.

To maintain voltage and reactive power within certain limits for safe and reliable power delivery, an electrical power generation and delivery system may include switched capacitor banks (SCBs) (e.g., capacitor 110), actuated by breaker 118 controlled by IED 138, configured to provide capacitive reactive power support and compensation in high and/or low voltage conditions within the electrical power system.

FIG. 2 illustrates an example of a timing diagram showing transmission of messages 200, 204 by an IED consistent with embodiments disclosed herein. More specifically, FIG. 2 illustrates an example of a timing diagram showing transmission of messages 200, 204 using a less-bandwidth conservative protocol such as GOOSE, although certain aspects of the illustrated timing diagram may also be reflected in a bandwidth conservative protocol. A message may include one or more control instructions, monitored system data, communications with other IEDs, monitored equipment and/or other network devices, and/or any other relevant communication, message, or data. In certain embodiments, a message may provide an indication as to a data state (e.g., a measured data state) of one or more components and/or conditions within an electrical power generation and delivery system. For example, a message may provide an indication of a measured current and/or voltage exceeding one or more thresholds. A certain data state (e.g., “Data State 1”) may be associated with a measurement exceeding such a threshold, while another state (e.g., “Data State 2”) may be associated with a measurement exceeding a different threshold. A message indicating a particular data state may be utilized to determine whether the measured current and/or voltage exceed the one or more thresholds. Similarly, a message may indicate a data state of a component of an electric power generation and delivery system such as a state of a breaker (e.g., “open” or “closed”), a power storage device (e.g., “charged” or “depleted”), and/or the like.

In certain embodiments, messages indicating a data state may be embodied as messages using one or more bandwidth conservative protocols and/or one or more less-bandwidth conservative protocols. A message may further indicate not only a particular data state, but also whether the message indicates a data state that is different than a data state indicated by one or more preceding message. That is, a message may include an indication that a data state associated with the message represents a data state change from a prior message. In certain embodiments, the prior message may be an immediately preceding message. In certain embodiments, data state change information may be indicated by a state change indicator (DSCI) included in the message. For example, a DSCI included in a message may be set to “1” following a data state change event. According to some embodiments, the SCIB may be asserted in only a first message following a data state change event. In other embodiments, the DSCI may be asserted for a specified period of time or for a specified number of messages (e.g., a message stream). The DSCI may be set to a different value upon a subsequent data state change event. By utilizing a DSCI, a receiving device may determine that a particular message indicates a recent data state change without having to examine certain contents of the message and/or previously received messages.

In certain embodiments, an IED may transmit to subscribing (e.g., receiving) devices and/or receive from publishing (e.g., transmitting) devices messages 200 reflecting a particular data state (e.g., “Data State 1”) at periodic intervals at a first communication rate after a certain period in which the data state has remained constant (e.g., a message stream). For example, if a measured data state has not changed within the last 30 seconds, an IED may transmit messages 200 at periodic intervals at the first communication rate. In certain embodiments, this periodic interval may be relatively long, reflecting that a data state change has not recently occurred. Transmitting the same or similar state messages periodically in a message stream may introduce a degree of redundancy, helping to ensure that subscribing devices receive messages during periods of network congestion and/or low network bandwidth conditions. Further, the continuous transmission may serve as an indicator that the transmitting device is continuing to operate as expected. Accordingly, the continuous stream of messages may be referred to as a “heartbeat”.

When a data state change occurs (e.g., at 202), the IED may publish and/or receive messages 204 reflecting the changed state (e.g., “Data State 2”) at periodic intervals having a second communication rate. As illustrated, in certain embodiments, the second communication rate may be faster than the first communication rate. Accordingly, the period between sequential messages 204 may be shorter than the period between sequential messages 200. As time progresses following the data state change event 202, the communication rate of the messages 204 may progressively slow to reach, for example, a rate at or near the first communication rate. In this manner, data state messages may be transmitted at a relatively fast rate immediately following a data state change event 202 that progressively slows as the data state change event 202 becomes older. According to some embodiments, the transmission rate may decrease exponentially for a period of time following the data state change event 202.

Transmitting measured data state messages at a faster rate after a data state change event 202 may ensure that devices subscribing to the communications (e.g., subscribing IEDs) are more likely to receive the messages indicating the data state change as closely as possible in time to the actual data state change event 202. Transmitting redundant messages at a relatively fast rate, however, may introduce network congestion and/or bandwidth issues in some devices (e.g., communication switches, routers, radios, multiplexors, a real-time automation controller, IEDs, PLCs, and/or the like).

FIG. 3A illustrates IEDs 302-306, 318 communicatively coupled with a network 300 via network switches 308-312 consistent with embodiments disclosed herein. Although embodiments illustrated in FIG. 3A are discussed in reference to IEDs 302-306, 318 and network switches 308-312, further embodiments may be implemented in other suitable IEDs and/or network devices. As discussed above, IEDs 302-306, 318 may be configured to communicate via a network 300 using messages that, in certain embodiments, may provide an indication as to a data state of one or more components and/or conditions within an electrical power generation and delivery system. In certain embodiments, IEDs 302-306, 318 and/or network switches 308-312 may be configured to communicate using one or more bandwidth conservative protocols and/or one or more less-bandwidth conservative protocols.

The network switches 308-312 may be configured to receive messages from the network 300 and to transmit certain messages to an associated IED 302-306, 318. For example, network switch 308 may be configured to receive messages from the network 300 and to transmit certain of the received messages to IED 302 and/or IED 318. As discussed above, in certain circumstances, a receiving IED (e.g., IED 302 and/or 318) may include a finite receiving FIFO that may only store a predetermined number of messages, and thus may not be capable of storing certain messages if a significant number of messages are received in a relatively short period (e.g., during periods of high network message traffic). Similarly, a network switch (e.g., network switch 308) may have a limited transfer rate that is lower than its receiving rate. For example, a network switch may have a 1 MB/second data transmission rate but a receiving rate that is substantially greater, thereby creating an asymmetry between inbound and outbound communication rates. If such a network switch includes a finite receiving and/or transmitting buffer and a substantial amount of data (e.g., a message stream) is received by such a network switch in a short period of time, the network switch may be unable to transmit received messages before the finite buffers become full and thus messages may be dropped or lost. In further circumstances, network devices and/or IEDs may have insufficient computing resources to process network traffic at “wire speed.”

Certain IEDs may utilize bandwidth conservative protocols (e.g., Mirrored Bits®, DNP, or the like) to manage the flow of messages and reduce the occurrence of dropped or lost messages and/or communication bottlenecks described above. Other IEDs, however, may not be configured to utilize a bandwidth conservative protocol, and may instead be limited to utilizing a less-bandwidth conservative protocol (e.g. GOOSE). Consistent with embodiments disclosed herein, certain IEDs, monitored equipment, and/or network devices may include a communication architecture allowing for communication between devices and/or stations implementing a variety of communication protocols (e.g., bandwidth conservative protocols and less-bandwidth conservative protocols). For example, one or more network devices may receive a message in a less-bandwidth conservative protocol from a first IED and may transmit a corresponding message to a second IED in a bandwidth conservative protocol.

FIG. 3B illustrates IEDs 302-306, 320 communicatively coupled with a network 300 via network switches 308, 312 and network radios 314, 316 consistent with embodiments disclosed herein. Certain elements of the system illustrated in FIG. 3B may be similar to those illustrated in and described in reference to FIG. 3A and, accordingly, similar elements may be denoted with like numerals. As with FIG. 3A, although certain illustrated embodiments are discussed in reference to IEDs 302-306, 320 network switches 308, 312 and network radios 314, 316, further embodiments may be implemented in other suitable IEDs and/or network devices.

IEDs 302-306, 320 may be configured to communicate via a network 300 using messages that, in certain embodiments, may provide an indication as to a data state and/or data state change of one or more components and/or conditions within an electrical power generation and delivery system. In certain embodiments, IEDs 302-306, 320 and/or network radios 314, 316 may be configured to communicate using one or more bandwidth conservative protocols and/or one or more less-bandwidth conservative protocols. The network switches 308, 312 and/or network radios 314, 316 may be configured to receive messages from the network 300 and to transmit certain messages to an associated IED 302-306, 320 using one or more suitable communication protocols. For example, network switch 308 may be configured to receive messages from the network 300 and to transmit certain of the received messages to IED 302 and/or IED 320. Similarly, IED 304 may communicate (e.g., exchange messages) with the network 300 via one or more network radios 314, 316 or other similar network devices implementing a wireless communication methodology.

Certain IEDs may utilize bandwidth conservative protocols (e.g., Mirrored Bits®, DNP, or the like) to manage the flow of messages and reduce the occurrence of dropped or lost messages and/or communication bottlenecks. Other IEDs, however, may not be configured to utilize a bandwidth conservative protocol, and may instead be limited to utilizing a less-bandwidth conservative protocol (e.g. GOOSE). Consistent with embodiments disclosed herein, certain IEDs, monitored equipment, and/or network devices (e.g., network radios 314, 316) may include a communication architecture allowing for communication between devices and/or stations implementing a variety of communication protocols (e.g., bandwidth conservative protocols and less-bandwidth conservative protocols). For example, network radio 314 may receive a message from the network 300 in a less-bandwidth conservative protocol and may transmit a corresponding message to network radio 316 in a bandwidth conservative protocol.

FIG. 4A illustrates communication between IEDs 400-404 and a network device 406 consistent with embodiments disclosed herein. Although certain embodiments are discussed in reference to IEDs 400-404 and network device 406, further embodiments may be implemented in other suitable IEDs, monitored equipment, and/or network devices. IEDs 400-404 may be communicatively coupled via a network device 406 that, in certain embodiments, may be a network switch. IEDs 402, 404 may be configured to communicate using one or more less-bandwidth conservative protocols (e.g., GOOSE, MMS, and/or the like). IED 400 may be configured to communicate using one or more bandwidth conservative protocols (e.g., Mirrored Bits®, DNP, FM, and/or the like).

To facilitate communication between IED 400 and IEDs 402, 404, network device 406 may receive a bandwidth conservative protocol message 408 from IED 400, reconfigure the bandwidth conservative protocol message 408 into a protocol understood by IEDs 402, 404 (e.g., a less-bandwidth conservative protocol), and transmit the reconfigured messages as less-bandwidth conservative protocol messages 410, 412 to IEDs 402, 404 respectively. For example, IED 400 may transmit a Mirrored Bits® message (e.g., message 408) to network device 406 which, in certain embodiments may be a network switch. IEDs 402, 404 may subscribe to messages generated by IED 400, but may be unable to communicate using the same protocol as IED 400. Accordingly, network device 406 may receive the Mirrored Bits® message and configure the Mirrored Bits® message as a corresponding message (e.g., a GOOSE message) that IEDs 402, 404 may understand for transmission to IEDs 402, 404. In this manner, communication between IEDs, monitored equipment, and/or network devices implementing variety of communication protocols may be facilitated.

FIG. 4B illustrates communication between IEDs 400, 404 and a network device 406 consistent with embodiments disclosed herein. Certain elements of the system illustrated in FIG. 4B may be similar to those illustrated in and described in reference to FIG. 4A and, accordingly, similar elements may be denoted with like numerals. Although certain embodiments are discussed in reference to IEDs 400, 404 and network device 406, further embodiments may be implemented in other suitable IEDs, monitored equipment, and/or network devices. IEDs 400, 404 may be communicatively coupled via a network device 406 that, in certain embodiments, may be a network switch. IED 400 may be configured to communicate using one or more bandwidth conservative protocols (e.g., Mirrored Bits®, DNP, FM, and/or the like). IED 404 may be configured to communicate using one or more less-bandwidth conservative protocols (e.g., GOOSE, MMS, and/or the like).

To facilitate communication between IED 400 and IED 404, network device 406 may receive a less-bandwidth conservative protocol message 414 from IED 404 intended for IED 400, reconfigure the less-bandwidth conservative protocol message 414 into a protocol understood by IED 400 (e.g., a bandwidth conservative protocol), and transmit the reconfigured message as a bandwidth conservative protocol message 416 to IED 400. For example, IED 404 may transmit a GOOSE message intended for IED 400 (e.g., message 414) to network device 406 which, in certain embodiments may be a network switch. IED 400 may subscribe to messages generated by IED 404, but may be unable to communicate using the same protocol as IED 404. Accordingly, network device 406 may receive the GOOSE message and configure the GOOSE message as a corresponding message (e.g., a Mirrored Bits® message) that IED 400 may understand for transmission to IED 400. In this manner, communication between IEDs, monitored equipment, and/or network devices implementing variety of communication protocols may be facilitated.

FIG. 5 illustrates communication between IEDs 500, 502 consistent with embodiments disclosed herein. Although certain embodiments are discussed in reference to IEDs 500, 502, further embodiments may be implemented in other suitable IEDs, monitored equipment, and/or network devices. As illustrated, IEDs 500, 502 may be communicatively coupled with each other. For example, IEDs 500, 502 may be communicatively coupled directly as illustrated or, alternatively may be communicatively coupled via one or more other IEDs, pieces of monitored equipment, network devices or components, and/or network communication channels.

IED 500 may be configured to communicate using a bandwidth conservative protocol. IED 502 may be configured to process information in a less-bandwidth conservative protocol (e.g., less-bandwidth conservative protocol messages such as, for example, GOOSE messages). As messages transmitted by IED 500 and received by IED 502 may be in a bandwidth-conservative protocol (e.g., message 506), IED 502 may include a module 504 that configures incoming messages received in the bandwidth conservative protocol into messages that IED 502 can process (e.g., less-bandwidth conservative protocol messages). Similarly, module 504 may reconfigure messages generated by IED 502 in a less-bandwidth conservative protocol (e.g., GOOSE) to a bandwidth conservative protocol (e.g., Mirrored Bits®, DNP, and/or the like) and transmit the reconfigured message (e.g., message 508) to IED 500. By reconfiguring incoming messages into a protocol that IED 502 can process, communication between IEDs, monitored equipment, and/or network devices implementing variety of communication protocols may be facilitated.

FIG. 6 illustrates communication between IEDs 600-606 and a network device 608 consistent with embodiments disclosed herein. Although certain embodiments are discussed in reference to IEDs 600-606 and network device 608, further embodiments may be implemented in other suitable IEDs, monitored equipment, and/or network devices. IEDs 600-606 may be communicatively coupled via network device 408 that, in certain embodiments, may be a real-time automation controller (RTAC). In certain embodiments, IEDs 600-606 may be configured to communicate using one or more bandwidth conservative protocols (e.g., Mirrored Bits®, DNP, and/or the like) and/or one or more less-bandwidth conservative protocols (e.g., GOOSE and/or the like). IED 600 may subscribe to messages 610-614 transmitted by IEDs 602-606. In certain embodiments, messages 610-614 transmitted from IEDs 602-606 may be in the same format (e.g., Mirrored Bits®, DNP, GOOSE, and/or the like). In further embodiments, messages 610-614 may be in different formats. For example, message 610 may be a Mirrored Bits® protocol message and messages 612, 614 may be GOOSE protocol messages. Accordingly, in such embodiments, network device 608 may be configured to receive messages in a variety of communication protocols.

In certain circumstances, IED 600 may only be capable of receiving and/or storing certain messages if a significant number of messages are received in a relatively short period (e.g., during periods of high network message traffic) due to, for example, a finite receiving buffer included in IED 600 or the like. Accordingly, if IEDs 602-606 all transmit messages 610-614 (e.g., “Message 1”, “Message 2”, and “Message 3”) at the same time or within a relatively short time period and IED 600 is not capable of receiving all of the message at the same time or within the time period, certain messages of the transmitted messages 610-614 may be lost and/or dropped.

To ensure that all messages are received by IED 600, certain messages (e.g., messages 610-614) transmitted by IEDs 602-606 may be routed through the network device 608. For example, messages 610-614 transmitted at the same time or within a relatively short time period may be routed through the network device 608. To ensure that messages transmitted to IED 600 are not lost and/or dropped due to periods of high network message traffic, network device 608 may configure (e.g., repackage) information included the messages 610-614 into a new message package 616. Configuring multiple messages 610-614 into a message package 616 may reduce the overall number of messages transmitted to IED 600, thereby reducing issues caused by high network message traffic and/or congestion conditions.

In certain embodiments, network device 608 may configure the information included in the messages 610-614 into a new message package 616 in a format that receiving IED 600 may understand. For example, if IED 600 is GOOSE-enabled, network device 608 may configure the message package 616 according to the GOOSE protocol. Similarly, if IED 600 is Mirrored Bits®-enabled, network device 608 may configure the message package 616 according to the Mirrored Bits® protocol.

In certain embodiments, network device 608 may be aware of the receiving capabilities of IED 600 and may use this information in determining a message format that IED 600 may understand. Network device 608 may be aware of the receiving capabilities of IED 600 through communication with IED 600, predetermined programming of network device 608, and/or any other suitable method.

Message package 616 may include information that associates particular information included in the message package 616 with a particular transmitting IED (e.g., IED 602-606). Using this information, the receiving IED 600 may identify what information contained in the message package 616 is associated with a particular transmitting IED. For example, the message package 616 may include one or more subscription identifiers associating certain information contained in the message package 616 with a particular transmitting IED.

FIG. 7 illustrates a flow chart of a method 700 of communicating between IEDs and/or network devices consistent with embodiments disclosed herein. Particularly, the illustrated method may be performed by network devices and/or IEDs that, in certain embodiments, may incorporate features of the systems illustrated in FIGS. 3-5. At 702, a device (e.g., a network switch, an IED, a module included in an IED, and/or the like) may receive a message in a less-bandwidth conservative protocol (e.g., GOOSE and/or the like). At 704, the device may generate a corresponding message in a bandwidth conservative protocol (e.g., Mirrored Bits®, DNP, and/or the like) by reconfiguring the message received at 702 into a bandwidth conservative format.

In certain embodiments, the particular bandwidth conservative format may be selected based on information about the message receiving and/or processing capabilities of an intended receiving device. In certain embodiments, this information may be included in the message received at 704. In further embodiments, this information may be obtained through communication with an intended receiving device, may be preprogrammed information, or may be provided to and/or accessed by the device performing method 700 using any other suitable method.

After reconfiguring the message into a bandwidth conservative protocol message, at 706 the reconfigured message may be transmitted to the intended receiving device. In certain embodiments, the identity of the intended receiving device may be included in the reconfigured message and/or the original message received at 702. For example, the message received at 702 may include subscription information identifying an intended receiving and/or subscribing device. Using this subscription information, the device performing method 700 may determine an intended receiving device for transmitting the newly generated message at 706.

FIG. 8 illustrates a flow chart of a method 800 of communicating between IEDs and/or network devices consistent with embodiments disclosed herein. Particularly, the illustrated method may be performed by network devices and/or IEDs that, in certain embodiments, may incorporate features of the systems illustrated in FIGS. 3-5. At 802, a device (e.g., a network switch, an IED, a module included in an IED, and/or the like) may receive a message in a bandwidth conservative protocol (e.g., Mirrored Bits®, DNP, and/or the like). At 804, the device may generate a corresponding message in a less-bandwidth conservative protocol (e.g., GOOSE and/or the like) by reconfiguring the message received at 802 into a less-bandwidth conservative format.

In certain embodiments, the particular less-bandwidth conservative format may be selected based on information about the message receiving and/or processing capabilities of an intended receiving device. In certain embodiments, this information may be included in the message received at 804. In further embodiments, this information may be obtained through communication with an intended receiving device, may be preprogrammed information, or may be provided to and/or accessed by the device performing method 800 using any other suitable method.

After reconfiguring the message into less-bandwidth conservative protocol message, at 806 the reconfigured message may be transmitted to the intended receiving device. In certain embodiments, the identity of the intended receiving device may be included in the reconfigured message and/or the original message received at 802. For example, the message received at 802 may include subscription information identifying an intended receiving and/or subscribing device. Using this subscription information, the device performing method 800 may determine an intended receiving device for transmitting the newly generated message at 806.

FIG. 9 illustrates another flow chart of yet another method 900 of communicating between IEDs and/or network devices consistent with embodiments disclosed herein. Particularly, the illustrated method may be performed by network devices and/or IEDs that, in certain embodiments, may incorporate features of the systems illustrated in FIG. 3-6. At 902, a device may receive messages from a plurality of IEDs, network devices, pieces of monitored equipment, and/or the like. In certain embodiments, all received messages may be associated with the same protocol (e.g., a less-bandwidth conservative protocol such as GOOSE or a bandwidth conservative protocol such as Mirrored Bits® or DNP). In further embodiments, the received messages may be associated with different protocols. Accordingly, in such embodiments, a device performing method 900 may be configured to receive messages in a variety of communication protocols.

At 904, information included in the messages received at 902 may be reconfigured (e.g., packaged) into a new message package. In certain embodiments, the new message package may be in a format that an intended receiving device may understand. For example, if a receiving device is GOOSE-enabled, the device performing method 900 may configure the message package according to the GOOSE protocol. Similarly, if a receiving device is Mirrored Bits®-enabled, the device performing method 900 may configure the message package according to the Mirrored Bits® protocol.

In certain embodiments, a device performing method 900 may be aware of the receiving capabilities of an intended receiving device and may use this information in determining a message format that receiving device may understand. The device may be aware of the receiving capabilities of the receiving device through communication with the receiving device, predetermined programming of the receiving device, and/or any other suitable method.

At 906, the device may transmit the message package to an intended receiving device. In certain embodiments, the message package may include information that associates particular information included in the message package with a particular device that originally transmitted the message to the device performing method 900 at 902 (e.g., a publishing device). Using this information, the receiving device may identify what information contained in the message package is associated with a particular transmitting device. For example, the message package may include one or more subscription identifiers associating certain information contained in the message package with a particular publishing device.

FIG. 10 illustrates a block diagram of a device 1000 for implementing certain embodiments of the systems and methods disclosed herein. In certain embodiments, the device 1000 may be a network device, network switch, modem, router, firewall, virtual private network server, and/or and any other suitable network device or system. Further embodiments may be implemented in an IED. As illustrated, the device 1000 may include a processor 1002, a random access memory (RAM) 1004, a communications interface 1006, a user interface 1008, and/or a non-transitory computer-readable storage medium 1010. The processor 1002, RAM 1004, communications interface 1006, user interface 1008, and non-transitory computer-readable storage medium 1010 may be communicatively coupled to each other via a common data bus 1012. In some embodiments, the various components of the network device 1000 may be implemented using hardware, software, firmware, and/or any combination thereof.

The user interface 1008 may be used to control certain features of the network device 1000 (e.g., via any suitable interactive interface to a user, one or more visual or audible status indicators, and/or the like). The user interface 1008 may be integrated in the network device 1000 or, alternatively, may be a user interface for a laptop or other similar device communicatively coupled with the computer system 1000. In certain embodiments, the user interface 1008 may be produced on a touch screen display. The communications interface 1006 may be any interface capable of communicating with other computer systems and/or other equipment (e.g., remote network equipment) communicatively coupled to computer system 1000.

The processor 1002 may include one or more general purpose processors, application specific processors, microcontrollers, digital signal processors, FPGAs, or any other customizable or programmable processing device. The processor 1002 may be configured to execute computer-readable instructions stored on the non-transitory computer-readable storage medium 1010. In some embodiments, the computer-readable instructions may be computer-executable functional modules. For example, the computer-readable instructions may include one or more functional modules configured to implement all or part of the functionality of the systems and methods described above in reference to FIGS. 1-9.

While specific embodiments and applications of the disclosure have been illustrated and described, it is to be understood that the disclosure is not limited to the specific configurations and components disclosed herein. Accordingly, many changes may be made to the details of the above-described embodiments without departing from the underlying principles of this disclosure. The scope of the present invention should, therefore, be determined only by the following claims.

What is claimed is:

1. A method for managing the exchange of messages between a first intelligent electronic device (IED) and a second IED included in an electrical power generation and delivery system performed by a network device comprising:
receiving, at a communications interface of the network device from the first IED, one or more messages configured according to a first communication protocol;
accessing information regarding one or more communication capabilities of the second IED;
determining, based on the accessed information, a second communication protocol;
reconfiguring the received one or more messages according to the second communication protocol to generate at least one reconfigured message; and
sending, via the communications interface, the at least one reconfigured message to the second IED.

2. The method of claim 1, wherein one of the first communication protocol and the second communication protocol is an IEC 61850 Generic Object Oriented Substation Events (GOOSE) protocol.

3. The method of claim 1, wherein one of the first communication protocol and the second communication protocol is a Distributed Network Protocol (DNP).

4. The method of claim 1, wherein one of the first communication protocol and the second communication protocol is a Mirrored Bits® protocol.

5. The method of claim 1, wherein the first communication protocol is a bandwidth conservative protocol and the second communication protocol is a less-bandwidth conservative protocol.

6. The method of claim 1, wherein the first communication protocol is a less-bandwidth conservative protocol and the first communication protocol is a bandwidth conservative protocol.

7. The method of claim 1, wherein accessing information regarding one or one or more communication capabilities of the second IED comprises communicating with the second IED to determine that the second IED is configured to communicate using the second communication protocol.

8. The method of claim 1, wherein accessing information regarding one or more communication capabilities of the second IED comprises accessing a database storing information indicating that the second IED is configured to communicate using the second communication protocol.

9. The method of claim 1, wherein the one or more messages comprise a subscription identifier.

10. The method of claim 1, wherein the second communication protocol is the GOOSE protocol, wherein the at least one reconfigured message is a message of a message stream comprising multiple redundant copies of the at least one reconfigured message, and wherein the sending step further comprises sending the multiple redundant copies of the reconfigured message.

11. A non-transitory computer-readable storage medium storing instructions that, when executed by a processor of a network device, cause the processor to:
receive, at a communications interface of the network device from a first intelligent electronic device (IED), one or more messages configured according to a first communication protocol;
access information regarding one or more communication capabilities of a second IED;
determine, based on the accessed information, a second communication protocol;
reconfigure the received one or more messages according to the second communication protocol to generate at least one reconfigured message.
send, via the communications interface, the at least one reconfigured message to the second IED.

12. The non-transitory computer-readable storage medium of claim 1, wherein one of the first communication protocol and the second communication protocol is an IEC 61850 Generic Object Oriented Substation Events (GOOSE) protocol.

13. The non-transitory computer-readable storage medium of claim 1, wherein one of the first communication protocol and the second communication protocol is a Distributed Network Protocol (DNP).

14. The non-transitory computer-readable storage medium of claim 1, wherein one of the first communication protocol and the second communication protocol is a Mirrored Bits® protocol.

15. The non-transitory computer-readable storage medium of claim 1, wherein the first communication protocol is a bandwidth conservative protocol and the second communication protocol is a less-bandwidth conservative protocol.

16. The non-transitory computer-readable storage medium of claim 1, wherein the first communication protocol is a less-bandwidth conservative protocol and the first communication protocol is a bandwidth conservative protocol.

17. The non-transitory computer-readable storage medium of claim 1, wherein accessing information regarding one or one or more communication capabilities of the second IED comprises communicating with the second IED to determine that the second IED is configured to communicate using the second communication protocol.

18. The non-transitory computer-readable storage medium of claim 1, wherein accessing information regarding one or more communication capabilities of the second IED comprises accessing a database storing information indicating that the second IED is configured to communicate using the second communication protocol.

19. The non-transitory computer-readable storage medium of claim 1, wherein the one or more messages comprise a subscription identifier.

20. The non-transitory computer-readable storage medium of claim 1, wherein the second communication protocol is the GOOSE protocol, the at least one reconfigured message is a message of a message stream comprising multiple redundant copies of the reconfigured message, and the sending step further comprises sending the multiple redundant copies of the reconfigured message.

21. A method performed by a network device for managing the exchange of messages between plurality of first IEDs and a second IED included in an electrical power generation and delivery system comprising:
receiving, at a communications interface of the network device from each of the plurality of first IEDs, first messages included in a first message stream, the first message stream comprising a plurality of first redundant messages;
reconfiguring at least one of the first messages from each of the plurality of first IEDs to generate a second message comprising information from at least one of the first messages from each of the plurality of first IEDs;
transmitting, from the communications interface of the network device to the second IED, the second message.

22. The method of claim 21, wherein the first messages comprise IEC 61850 Generic Object Oriented Substation Events (GOOSE) messages.

23. The method of claim 21, wherein the second message comprises a Distributed Network Protocol (DNP) message.

24. The method of claim 21, wherein the second message comprises a Mirrored Bits® message.

25. The method of claim 21, wherein the second message is a message included in a second message stream comprising multiple redundant copies of the second message.

26. The method of claim 21, wherein the second message further comprises identification information associating a least a portion of the information included in the second message with at least one of the plurality of first IEDs.

27. The method of claim 21, wherein the identification information comprises a subscription identifier.

28. The method of claim 21, wherein the second message is configured according to a communication protocol selected based on information regarding one or more communication capabilities of the second IED.

29. The method of claim 28, wherein the method further comprises communicating with the second IED to determine that the second IED is configured to communicate using the communication protocol.

30. The method of claim 28, wherein the method further comprises accessing a database storing information indicating that the second IED is configured to communication using the second communication protocol.
